(19) United States
(12) Patent Application Publication
(10) Pub. No.: US 2006/0195583 A1
(43) Pub. Date: Aug. 31, 2006

(54) Method and system for providing information services to a client using a user profile

(76) Inventors: Fabio Bellifemine, Torino (IT); Alessandro Chiarotto, Torino (IT); Angelo Difino, Torino (IT); Barbara Negro, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/546,831

(22) PCT Filed: Feb. 27, 2003
(86) PCT No.: PCT/EP03/02003

§ 371 Date: Aug. 25, 2005

(51) Int. Cl. G06F 15/16

(52) U.S. Cl. 709/227

(57) ABSTRACT

Information content is provided from at least one server to at least one user terminal, the information content being customized according to a user model. To that end at least a portion of the user model provided at the user terminal is sent from the user terminal to the server thus making it available to the server. The information is customized on the basis of the user model as made available to the server and sent from the server to the user terminal. The portion of the user model possibly stored at the server is eventually deleted from the server.

1. Field of the Invention

The present invention relates to systems for providing information services such as e.g. multimedia services. The invention was developed by paying specific attention to the possible use in association with telecommunication systems such as telecommunication networks, like e.g. the Internet.

In such networks, users are able to access multimedia contents stored in so-called servers by resorting to client-server data exchange techniques.

2. Description of the Related Art

Systems for providing multimedia services allow a user to receive at a user terminal, such as a personal computer, a mobile phone or a TV set, selected digital items such as news and information, mail and entertainment, while also permitting social interactions by the user.

Use of such systems is becoming more and more widespread with the introduction of hand held computers and interactive television, thus leading to such systems being accessed by an increasing number of untrained users.

Therefore, truly effective systems for providing multimedia services should not only maintain information adapted to be accessed by the users, but also provide active “customisation” of the information contents delivered to different users, while also facilitating automatic retrieval of information of special interest for the user.

This kind of tailoring of the information according to the user's needs is often referred to as Personalized Information Services (PIS). The technique used for performing such customisation tasks on the Internet or in a similar network is called user modelling, as a person skilled in the art well knows.

User modelling, for instance, in regard to the television industry, can be implemented by means of so called Electronic Programming Guides or EPG, which are able to automatically guide a given television user or homogeneous group of users in choosing TV programmes (events) to be viewed.

Such tools differ from each other according to the manner or criterion, inherent to the EPG tools, whereby is generated a table or parameter class able to determine the programming of those events which, within the scope of accessible parameters, correspond with a given user's expectations.

Known EPG tools are constituted by software modules called “Expert modules”, able to generate parameter classes called “predictions” to be used to automatically select the events to propose to the user. Such “predictions”, in general, are representative of elements which, possibly combined with further elements, representative of personal data of the user, cooperate to the building of the so called “user model”.

Therefore the “user model” comprises, in general, a plurality of elements representative of the will of a user or a group of users and can be used as a whole or partially in order to automatically select or customise the information of interest for a user or a group of users.

A user model, in short, is a process that, starting from user data (“user profile”) can generate context based predictions on user interests and/or preferences. As a matter of example, the “predictions” can be generated by at least three Expert modules, respectively the Explicit Preferences Expert, the Dynamic Expert and the Stereo-Typical Preferences Expert modules or combinations thereof.

Tools that use the Explicit Preferences Expert (Explicit Expert) module allow to generate the “predictions” class based on indications explicitly expressed by the user.

Tools that use the Dynamic Expert module (Dynamic or Implicit Expert) allow to generate the “predictions” class based on the user's previous choices.

Lastly, Tools that use the Stereo-Typical Preferences Expert module (Stereo-Typical Expert) use stereotypes or categories based, for instance, on the user's age, gender, etc. to identify the “predictions” class to be used in selecting the items to be proposed.

A user model can be advantageously represented by a tree structure. For example, according to the MPEG-21 standard, branches can represent preferences or categories, personal data, explicit preferences, browsing preferences.

User modeling can be applied, for instance, in order to generate a multimedia content catalogue, containing a list of digital items available for downloading or streaming at the user terminal. Through user modeling, the list of digital items is, therefore, customized.

Generally, the user modeling task can be performed either on the client side, i.e. the user side, or on the server side, i.e. the side of the service provider.

FIG. 1 is a schematic diagram of a system using the client side approach.

In the system shown, designated 100 as a whole, the contents to be transmitted and their descriptions are broadcast in an undifferentiated manner towards all the users in the system. In FIG. 1 only the client or user side is shown, where a satellite antenna 140 and a terrestrial antenna 150 receive TV signals and feed a TV terminal 110. This is typically a set top box or other similar equipment, connected to a TV set 120. In the TV terminal 110, a personalization module 111 is provided that contains a user model. The model stored in the module 111 permits a subset of items held to be more interesting for the user to be selected among all the items broadcast.

Being located on the client side, the personalization module 111 can obtain user information easily and timely by analysing the user behaviour and thus “learning” from the previous interactions of the user with the TV terminal 110, e.g. the selections performed through a remote control 130. Moreover, client-side user modeling is safe and makes the user confident in that he or she has complete control over his or her own user model and any file related thereto.

In a client-server system (i.e. a data exchange system where the client requests a service from the server, and the server fulfils the request), the client-side user modeling approach shown in FIG. 1 is not considered appropriate and efficient. This is held to be particularly true in the case client and server are interconnected over a network.

More to the point, this approach will not permit the user to selectively access services/data for which specific entries are not included in the model available at the user terminal: a user wishing to access, e.g. only certain selected sections of a news service, will thus be forced to download a whole set of data, including, in addition to the specific information the user wishes to access, additional data that are of no interest for the user. This is a highly penalizing situation for those users using terminals having reduced processing capabilities such as e.g. mobile phones.

Under these circumstances, server-side user modeling is preferably adopted. A schematic diagram of a corresponding client-server system 200 according to the prior art is shown in FIG. 2.

In the arrangement shown in FIG. 2, the server 250 keeps and manages all the relevant information about the user. Such information is arranged in user modules or files 251 that reside at the server 250. The server 250 also includes a personalization module 252. On the basis of the information contained in the user modules 251, the personalization module 252 indexes and searches a contents database 253, where the contents to be delivered to the clients reside as digital items.

A user terminal such as e.g. a telephone 210, a hand held computer 220 or a personal computer 230, communicates with the server 250 through a network 240, usually the Internet network.

Since the user modules 251 reside at the server, each time the user subscribes a new service a corresponding profile is to be registered. This operation includes sending personal information over the network. This is usually done by filling a form provided by an application running on the server. Thus, in order to establish a user model on the server side, the necessary information must be transmitted from the client to the server over the Internet network 240.

User modeling on the server side is thus exposed to possible concerns in terms of privacy and security. Generally, it requires the user to have a high degree of confidence in the prospected use of his or her own personal data by the service provider that maintains the server.

Another drawback is that the user models stored at the server may not be specific for each single user, but rather correspond to aggregate profiles regarding a plurality of users. Oftentimes, for each service there is a fixed, limited set of pre-defined user models among which the user has to choose when registering.

In patent application US2001/0013123 a method for generating user models, in particular for broadcast services, is disclosed wherein the user parameters are gathered via the user terminal and sent to the server to be processed there in order to establish a user model. The user model is then sent back from the server to the user terminal. Such a method inherently suffers from the same drawbacks considered in the foregoing, and also generates an appreciable amount of additional traffic.

### OBJECT AND SUMMARY OF THE INVENTION

The object of the present invention is thus to overcome the drawbacks of the prior art arrangements considered in the foregoing while providing improved information services.

According to the invention, such an object is achieved by means of a method having the features set forth in the annexed claims, which form an integral part of the description herein.

The invention also relates to a corresponding system, such system being in the form of a network or a part of a network. The invention also covers terminals configured to operate in conformity with the invention and a corresponding computer program product directly loadable in the memory of a digital computer (such wording obviously including a computer network) and comprising software code portions for performing the steps of the method of the invention and/or implementing a component of the system of the invention when the product is run on a computer.

Essentially, a preferred embodiment of the invention is a system for providing multimedia services that includes at least one server. The server is connected, through a network, to a user terminal, for sending the information content to the terminal. The server is adapted for customizing the information content according to a user model.

The user terminal is in turn adapted for providing a user model at the user terminal, for selecting at least a portion of the user model on the basis of the service, and for sending the selected portion of the user model from the user terminal to the server.

and sending at least a part of the user model to the server for temporary use and possible storage at the server. Once the transaction is completed, the user model information possibly stored with the server is deleted.

### BRIEF DESCRIPTION OF THE DRAWINGS

Further objects, features and advantages of the present invention will become apparent from the following detailed description and annexed drawings, provided by way of non-limiting example only, wherein:

FIGS. 1 and 2 have been already described extensively in the foregoing;

FIG. 3 shows a basic diagram of a system according to the invention;

FIG. 4 and 5 are flow charts of certain steps of a method carried out in the system of FIG. 3;

FIG. 6 shows a basic diagram of a variant to the system of FIG. 3; and

FIG. 7 shows a basic diagram of a further variant to the system of FIG. 3.

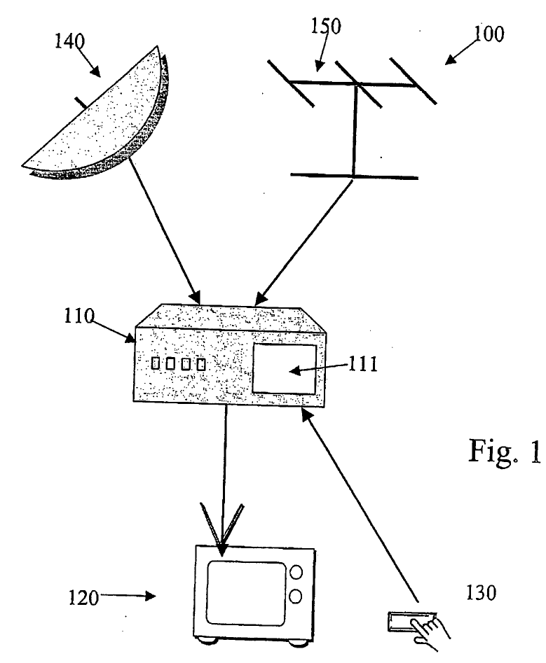

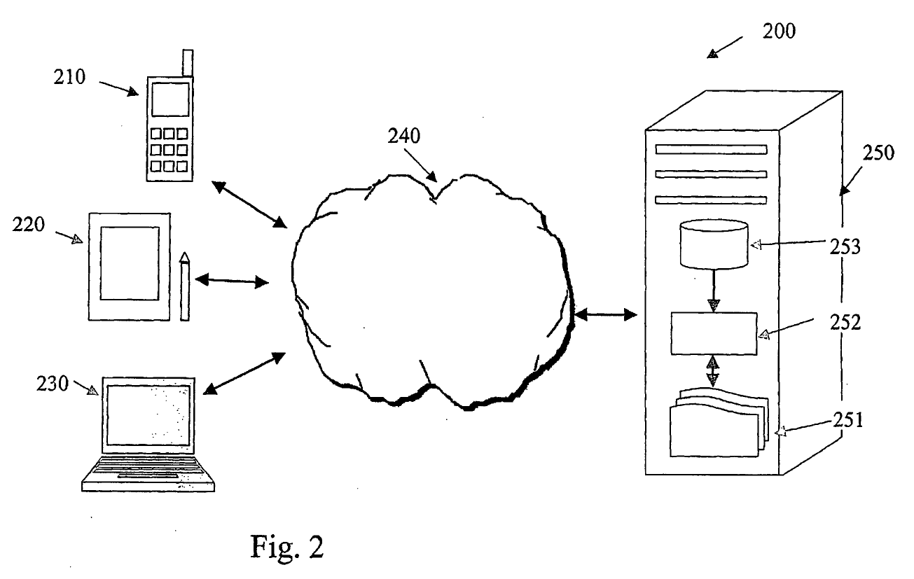

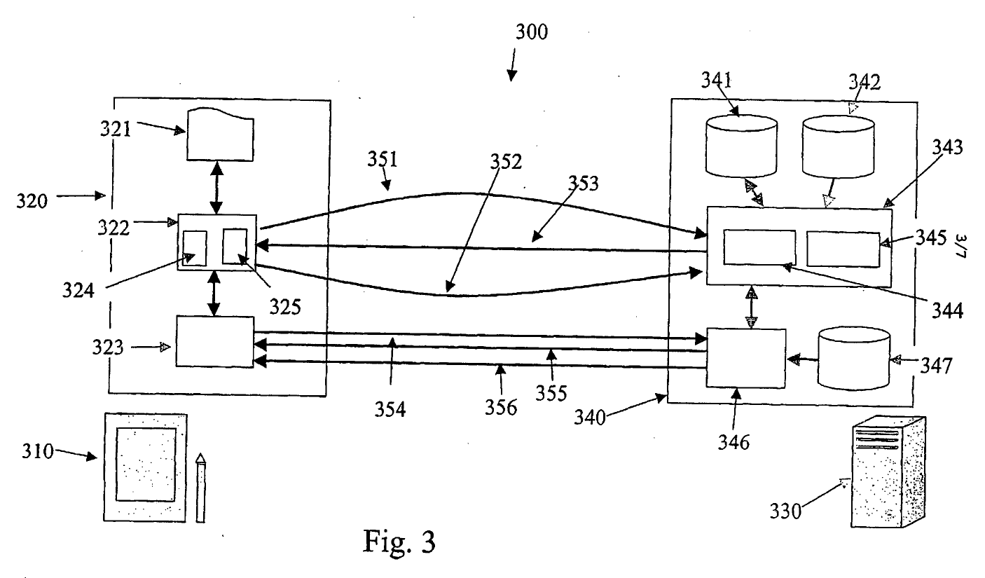

FIG. 3 shows is a basic block diagram of a system for providing multimedia services.

The system, indicated 300 as a whole, generally includes a plurality of user terminals. One such terminal, designated 310, is connected to a respective server 330 over a network such as the Internet, a GPRS or UMTS network, these being of course just non-limiting examples.

The user terminal 310 may be in the form of a hand held PC, as is the case of the embodiment shown in FIG. 3. Alternatively, it may be a personal computer, a mobile phone, a set top box or analogous apparatus. The terminal 310 includes a client module 320.

The server 330 hosts a server module 340 of a service provider. Several servers 330 can be connected to the network, supplying at least partly different services.

In FIG. 3, items indicated with reference numbers from 351 to 355 represent elements of transactions effected over the network using e.g. the Internet Protocol (IP).

The client module 320 comprises a client application 322 for dealing with the client/server transactions, including a user modeling engine 324 and a user model manager module (flying profile manager module) 325. The user modeling engine 324 calculates and manages the complete user model 321 with different known techniques. The flying profile manager module 325 is the module responsible for the selection of the portion of the user model to be sent to the server and for the negotiation process of sensible data between client and server as deeply explained in the following sections.

For example, in the first step the flying profile manager module 325 can select a portion of the user model to be sent to the server, i.e. one or more branches of the user model representative of the category of the service required by the user.

Preferably, the branch (or branches) including personal (and sensitive) data is not sent to the server in the first step, and is only made available through a specific negotiation.

The module 320 also includes a client media facility 323, i.e. apparatus such as a media player for the reproduction of multimedia contents.

A user model 321 resides in the client module 320 at the user terminal 310. The model 321 is stored and managed by the user modeling engine 324.

The server 330 includes three different databases:
a user database 341, adapted for storing—in the form of temporary files, as better explained in the following—the user models 321 or parts thereof;
a content database 347, where the multimedia information content is stored;
a content description database 342 that contains brief descriptions of the available multimedia information stored in the content database 347.

The server 330 also comprises a server application 343, for generating personalized and customized catalogues for the content description database 342, and a media server 346, that is a module adapted for handling the client/server transactions on the server side and thus able to transmit descriptions or multimedia information contents to the user terminal 310.

The server application 343 comprises a personalization module 344 and a customiser module 345. On the basis of the portion of user model 321 (partial or complete), the personalization module 344 filters the available descriptions or multimedia information content items in order to identify a subset thereof held to be of interest for the user. Of course, such activity being performed “on the basis” of the user model includes arrangements where personalization is obtained by the interaction of that model and other tools already available at the server.

An example of such tools is “collaborative filtering”, wherein the server can generate predictions by comparing choices made by different users in a similar context.

The customiser module 345 adapts the descriptions or multimedia information content transmitted to the user terminal 310 according to user preferences, terminal capabilities, network status and other parameters that can influence the format of information.

Those of skill in the art will promptly appreciate that the various elements described in the foregoing can be hosted on different servers and machines. Specifically, the user terminal 310 can host the user model 321 and contain the client application 322, and the user modelling engine 324 that manages the personalization functions—while being in any case arranged on he “client” side—can reside on the hardware of the telecommunications provider.

This may represent a preferred choice when the user terminal is a mobile phone. In that case, the user model is stored in the SIM card and the mobile phone operator manages the user models and interfaces the user terminal via application services providers.

Operation of the system shown in FIG. 3 will now be described.

A user that desires to access a particular service, for example a news service, activates the user terminal 310 that contains the client application 322, i.e. the application for accessing the news, and the client media facility 323, that will allow reproduction of a multimedia content such as a audio/video message, and an instance of the user model 321. This means that, on the client side, the user modeling engine 324 will have available and manage a complete user model 321, defined e.g. according to the MPEG-21 standard.

In order to obtain an improved, more accurate personalization, the basic information required according e.g. to the MPEG-21 standard can be supplemented with additional useful data. The user modeling engine 324 operates by taking advantage of all the personal data available, such as e.g. age, gender, sex, interests, hobbies, explicit preferences, and also the usage history recorded during the previous sessions.

On the basis of this information, or part thereof, the user modeling engine 324 is in a position to predict (by resorting to well known techniques) e.g. the types of news and usage characteristics that better suit that particular user.

By way of example, if the information stored in the user model 321 portrays the user as a businessman in the age of forty, while the usage history indicates that the user frequently accesses financial and political news, the user model engine 324 will predict that the user will expectedly prefer news with financial and political contents while showing less interest in e.g. gossip.

When contacting the service provider 340 that provides the respective information service, the client application 322 will start the transaction by sending, for example as an HTTP request, a catalogue request 351.

The client application 322, and in particular the flying profile manager module 325, will also send separately a—partial or complete—copy 352 of the user model 321 stored in the user terminal 310. In a simple case, the client module 320 will send to the server 330 only the user preferences about the different categories, i.e. Financial News, Gossip, Music News, etc . . . , whereas in a more complex case the user model 321 will also specify what items of information are held to be private and what data the user may agree or may not agree to diffuse.

The copy 352 made available to the server being possibly a partial copy means i.e. that the user can positively select portions of the user model that the user may not wish to be communicated in any case to the server. The arrangement disclosed herein is thus adapted to operate in full compliance with existing laws and regulations in the area of protection of privacy.

When the server 330 receives the (partial or complete) copy 352 of the user model, it opens a session, which usually leads to the copy 352 of the user model 321 being cached in the user database 341.

Possible caching is any case intended to be only for use at the session, the copy 352 of the user model 321 being thus a “volatile” copy. In fact, when the user closes the session, the copy 352 will be deleted from the server 330. This may occur either directly as a result of the session being closed or after a predetermined time interval (expiration time) possibly identified by additional information sent from the user terminal to the server together with the user model. Such an expiration time can be, for example, a time interval of 1, 5, 10, 60 minutes until one day or a determines number of sessions spaced by the above time intervals.

On the basis of the (volatile) copy 352 of the user model 321, the server application 343 contained in the server 330, sorts all the available items in the content description database 342. This occurs in a manner that is known per se and leads to generating a personal catalogue 353, listing those news descriptions that better suit the user model.

Of course, the personal catalogue being generated “on the basis” of the partial or complete copy of the user model 352 may well include arrangements where the catalogue in question is generated by the interaction of that copy and other user modelling tools already available at the server.

The personal catalogue 353 is sent from the server 330 to the client application 322 in the client module 320, where the user can finally browse his or her personal catalogue 353, with the additional possibility of selecting the information to be presented to the user on the basis of further criteria. These criteria are not required to be communicated to the server and may be directed to e.g. “black list” or other filtering activities on the basis of the age and the role of the user.

We propose a possible embodiment of the invention for the compilation of a guide related to the cinema: the user wants to view, on his terminal, a list of the more interesting available films.

Whenever a client wants to request such a personalized service to a server the following steps are processed:
the flying profile manager module 325 selects, from the user model 321, e.g. in the MPEG-21 format, that contains a complete picture of the user, the nodes that represents the user preferences for the categories movie-horror, movie-thriller, movie-comedy, movie-romance, and so on. For example the selected portion of the user model is the following one:
   userName=JohnDoe,
   pref(movie-horror)=100,
   pref(movie-thriller)=50,
   pref(movie-romance)=−100.
the client application, and in particular the flying profile manager module 325, sends this portion of the user model to the server
the server component 342 uses or saves temporarily this portion of the user model into the user database 341
the personalisation module 344 on the server uses these pieces of information coming from the client to select, from the content description database 342 and according to well-known techniques of matchmaking, the suitable content. For example the film “Sixth Sense” with categorization movie-thriller will be selected, instead the film “Pretty woman” with categorization movie-romance will be discarded.
the catalogue of these selected films is returned to the client

From this description it is clear that only the user preferences related to the content categories are sent to the server and no sensible data are passed on to the service provider, guaranteeing the user privacy.

The personal catalogue 353 can also be personalized with different graphic user interfaces (GUIs) and layout according to the selected user.

When the user has browsed through his or her personal catalogue 353 and has read a brief description associated to each item of news, the user can select an item from the list in order to have the corresponding multimedia content presented. This can be e.g. a short video prepared by the service provider.

The selection is recorded by the user modeling engine 324 that, by constantly monitoring the user's interactions with the user terminal 310, updates, refines and improves the complete user model 321 residing in the client module 320, in order to obtain better predictions.

The selection is then transmitted from the client media facility 323 in the user terminal 310 to the media server 346 in the server 330 in the form of a content request 354. The media server 346 retrieves the content requested from the content database 347. If necessary, this may occur in combination with customisation:
according to the user's preferences, e.g. the user prefers to watch a summary of the news,
according to the terminal capabilities, e.g. only a low-level video format an be presented on a handheld PC, and/or
according to the network capabilities, e.g. for taking into account that a GPRS connection is slower than a TCP/IP connection.

The same personalization module 343 previously employed for generating the personal catalogue 353 is used for such a customisation to produce customized multimedia information content 355. This is finally transmitted to the client module 320, where it can be viewed on the user terminal 310.

If the server 330 needs a specific item of information concerning the user, the server 330 can request this from the client module 320.

By way of example, the customiser module 345 that adapts the content for a given user and terminal, may need “age” information e.g. in order to filter out or block inappropriate sequences. For meeting these needs, a special transaction 356 may be provided between the server 330 and the client 320. The server 330 requires the age information from the flying profile manager module 325 and flying profile manager module 325 replies only if the user agrees.

Obviously this may occur either as a result of direct user interaction (i.e. a direct reaction of the user to a request presented on the user terminal) or by means of a suitably programmed user agent such as a software module.

Suppose for example that the server would like to know, in the composition of the catalogue, also the attribute “age” of the user
the server component 344 sends the requests for this additional information to the client application 320, and in particular to the flying profile manager module 325
the flying profile manager module 325 could
   1. consult the indications and instructions that the user has delegated to his personal agent, and therefore reply to the server with a “No, this information is private” or “Ok, the age of my user is 29”
   2. consult explicitly the user and follow his real-time indications
if the server receives the required attribute “age” it will be able to refine in a better way the catalogue (for example discarding movie-horror if age<18)
if the server doesn't receive the required attribute, the resulting filtering and compiling of the catalogue could be less close to the real user's desires.

This means that control over personal data and information is always and fully on the user side and, thanks to this process, the invention allows not only the distribution of a portion of the user model, but also the negotiation of sensible data between the server and the client, depository of the complete user model.

After the personalized and customized information content 355 has been sent to the client module 320, any other subsequent user selection can be used in order to better refine the user model 321 and learn more about the user: for instance the user having skipped some sequences or having viewed repeatedly the same content can be recorded as a part of the usage history.

The solution described in the foregoing offers the advantages of client-side user modeling in term of flexibility in updating the user model, while maintaining a high degree of security since the user model is made available with the server only temporarily, e.g. by caching it. If possibly stored at the server (in any form) the user model is subsequently deleted, for instance when the session is closed.

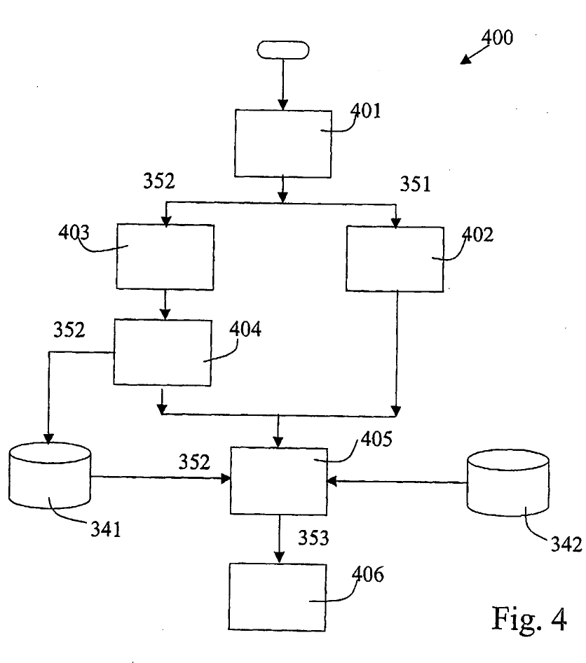

The operating steps carried out by the system 300 for obtaining the personal catalogue 353 are represented in the flow chart of FIG. 4.

There, reference 401 indicates a step where the user issues the request 351 for a personal catalogue 353.

The block 402 represents a step where the request 351 (formulated through the client application 322) reaches the server application 343.

While the step 402 is being performed, in a step 403 the client application 322 also sends to the server application 343 the copy 352 of the user model 321; further in step 404, the server application 343 temporarily saves the copy 352 of the user model 321 in the user database 341.

The system then evolves to a step 405, where the personalization module 344 generates a personal catalogue 353. This occurs on the basis of information contained in the copy 352 of the user model 321 taken from the users database 341 and on the basis of content descriptions from the content description database 342.

In a step 406 the server application 343 sends the personal catalogue 353 to the client application 322.

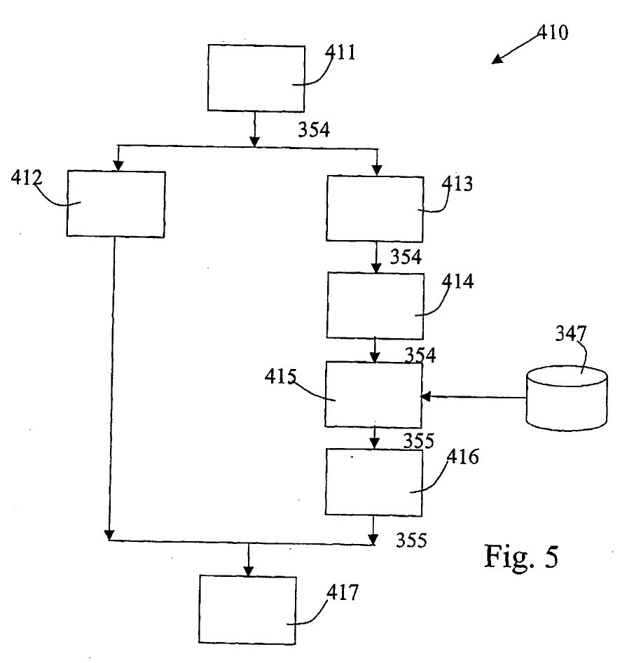

FIG. 5 is a flow chart of the operations carried out when the user selects a specific content.

In a step 411 the user selects, in his or her client application 322, specific information content from the personal catalogue 353.

In a step 412 the user modeling engine 324 uses the selection information in a learning and updating process for the user model 321.

While the step 412 is being performed, in a step 413, the content request 354 is forwarded from the client application 322 to the client media facility 323.

Then in a step 414 the client media facility 323 sends the content request 354 to the media server 346.

In a step 415 the media server 346 retrieves the content from the content database 347 and, under the control of the server application 343, creates a personalized and customized version 355 of the requested content.

In a step 416 the media server 346 sends the customized information content 355 to the client media facility 323 and, therefore, the user.

In a step 417, the process of step 412 is accomplished and any other user's action on the client media facility 323 during the viewing of the multimedia content can be used in the learning process of the user modeling engine 324.

When the user closes the application on the user terminal 310, or does not use it for a specified time interval, the session is considered closed and the copy of the user model 321 possibly stored in the server 330 is deleted.

In that way the user has a high level of confidence in the safety of the application, because, in the first place, the user can deny the transmission of any of his or her personal data to the server, and because, in the second place, the personal model is made available at the server only temporarily and, if possibly stored at the server, is deleted at the end of the transaction.

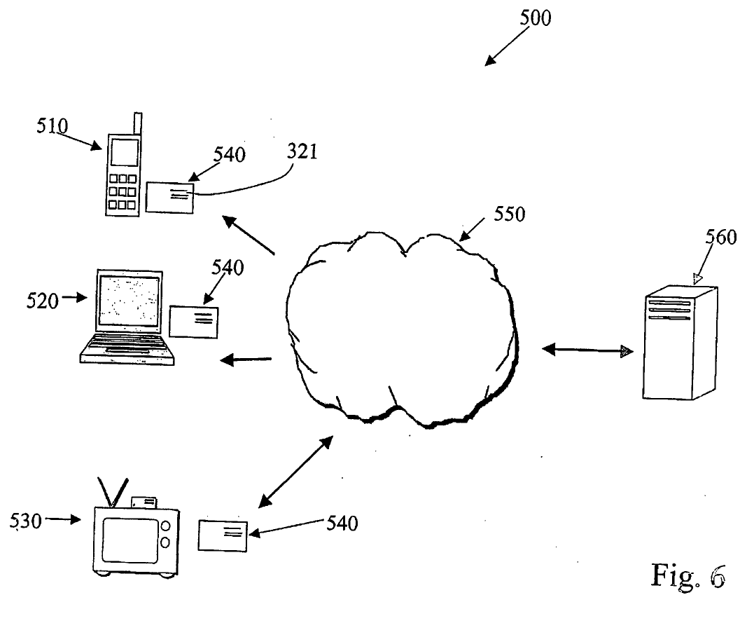

Another important feature of the arrangement described is now illustrated in connection with FIG. 6.

The system 500 shown in FIG. 6 provides for the possibility of storing the user model 321 in removable piece of equipment.

In FIG. 6 reference 540 indicates a smart card 540 that can be used in association with a mobile phone 510, a personal computer 520 and/or a TV set 530, each of these including a client application 322 and a client media facility 323 as described in the foregoing.

The user can use the mobile phone 510 when away from home, or the personal computer 520 when at home, or the TV set 530 along with a set top box, by simply inserting in the terminal he or she wishes to use the smart card 540 where the user model is stored. In this way, all the relevant information about the user profile and preferences can be stored and used by different terminals, without the need of repeating for each terminal registration procedures and/or learning processes.

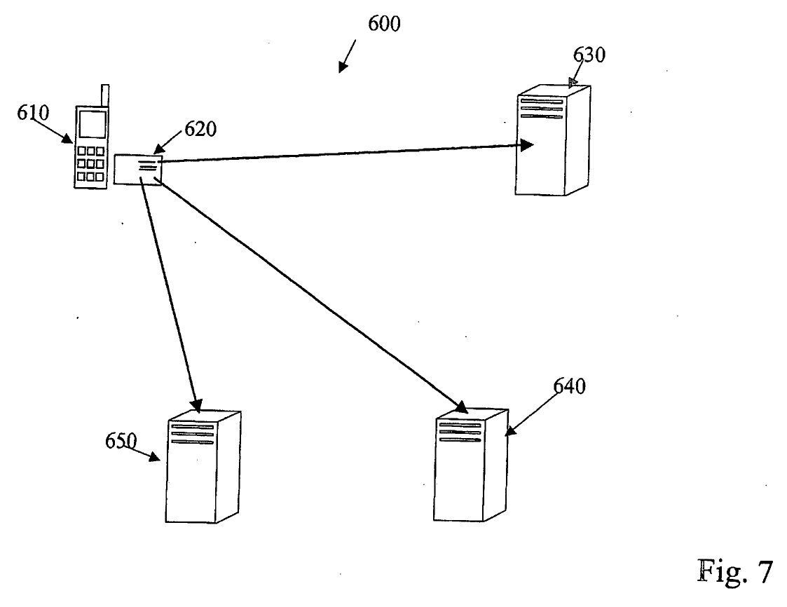

FIG. 7 is a schematic diagram of a further variant of the arrangement described herein, where a system 600 includes different servers 630, 640, 650 that provide different services.

The arrangement described in the foregoing by referring to co-operation of a user terminal with one server may be easily extended to such a scenario including a plurality of servers,

This arrangement provides additional advantages for the user, such as e.g.:
the user model may be continuously updated by making sure that updated information is communicated to all the servers involved at each new session, and
different portions/versions of the user model can be provided to different servers.

In the system 600 a user may operate a terminal user 610 with a smart card 620 containing a user model 321 e.g. of the MPEG-21 compliant type. The service on server 630 and service on server 640 (or on server 650) being e.g. MPEG-21 compliant, the user model 321 prepared for browsing or surfing on the server 630 can be used also in connection with the server 640 and also the services provided therein. The user's interactions and activities with respect to services on either of servers 630 and 640 may thus be used to complete, update and improve the user model 321 in the terminal 610.

This is advantageous since, for subscribing the service on the server 640, no need exists for the user of e.g. registering a new user identifier, filling in a new form with the personal data etc . . . . Most significantly, the user model 310 supplied to the new service server is a fully trained one, that is a user model already shaped with a history of the user's habits.

Of course, the specific details of implementation of each one of the arrangements previously considered can be applied to the other arrangements disclosed.

The arrangements exemplified herein are adapted for use in client/server data exchange systems that are connected through Internet Protocol networks. However, these arrangements can be applied also to systems associated with different networks.

Encrypted and, in general, encoded transmission can be advantageously adopted in client-to-server and server-to-client considered herein.

The arrangements exemplified are suited for implementation on user terminals and servers that have processing and communication capabilities. They can thus be implemented by programming a user terminal and/or a server by means of a suitable computer program product. Again, suitably programming a general-purpose processor architecture on the basis of the present disclosure falls within the ordinary programming capability of those of skill in the art.

It is thus obvious that many changes of the exemplary embodiments shown herein are evident for the man skilled in the art, without departing from the scope of the invention as defined by the claims that follow.

1-26. (canceled)

27. A method for providing information content in relation to a service from at least one server to at least one user terminal, said information content being customized according to a user model comprising the steps of:
providing said user model at said user terminal;
selecting at least a portion of the user model on the basis of the service;
sending at least a portion of the user model from said user terminal to said server thus making said at least a portion of the user model available to said server;
customizing said information on the basis of said at least a portion of the user model made available to the server; and
sending said customized information from said server to said user terminal.

28. The method of claim 27, further comprising the steps of:
storing at the server said at least a portion of the user model; and
subsequently deleting from the server said at least a portion of the user model stored at the server.

29. The method of claim 27, comprising the step of providing a user model engine for establishing said user model at the user terminal.

30. The method of claim 27, comprising the steps of carrying out a learning process by recording user interactions with the user terminal and updating said user model at the user terminal by means of said learning process.

31. The method of claim 27, comprising the steps of:
sending from the server to the user terminal a request for additional information to supplement said at least a portion of the user model made available to said server;
submitting said request to a user or to a user agent for approval; and sending said additional information from the user terminal to the server only if the user or the user agent approves the request.

32. The method of claim 27, wherein said user model is compliant to the MPEG-21 standard.

33. The method of claim 27, wherein said at least a portion of said user model is made available to the server as a partial copy of said user model containing only a part of the data contained in said user model.

34. The method of claim 27, comprising the steps of:
providing a plurality of servers with respective information contents; and
accessing said plurality of servers via said at least one user terminal, wherein said accessing takes place by using the same user model provided in said at least one user terminal by sending at least a respective portion of said user model from said user terminal to the servers of said plurality of servers.

35. A system for providing information content from at least one server to at least one user terminal requesting information content from the server in relation to a service, said information content being customized according to a user model, comprising:
at least one user terminal comprising a user model engine for providing said user model at the user terminal, a user model manager module for selecting at least a portion of the user model on the basis of the service, and a transaction engine for sending at least a portion of the user model from said user terminal to said server thus making said at least a portion of the user model available to said server; and
at least one server comprising a server engine for customizing said information on the basis of said at least a portion of the user model made available to the server and sending said customized information from said server to said user terminal.

36. The system of claim 35, wherein said server engine comprises:
storing modules for storing at the server said at least a portion of the user model; and
deleting modules for subsequently deleting from the server said at least a portion of the user model stored at the server.

37. The system of claim 35, wherein said user model is compliant to the MPEG-21 standard.

38. The system of claim 35, wherein said user model manager module of said user terminal is configured for making available to said at least one server a partial copy of said user model containing only a part of the data contained in said user model.

39. The system of claim 35, comprising:
a plurality of servers with respective information contents; and
at least one user terminal configured for accessing said plurality of servers by using the same user model provided in said at least one user terminal and by sending at least a respective portion of said user model from said user terminal to the servers of said plurality of servers.

40. The system of claim 35, comprising a data carrier for storing said user model, whereby said data carrier is adapted for use with a plurality of user terminals.

41. An Internet network comprising the system of claim 35.

42. A user terminal for use in a system for providing information content in relation to a service from at least one server to said user terminal, said information content being customized according to a user model, said user terminal comprising a user model engine for providing said user model at the user terminal, a user model manager module for selecting at least a portion of the user model on the basis of the service, and a transaction engine for sending at least a portion of the user model from said user terminal to said server thus making said at least a portion of the user model available to said server; wherein said user terminal is configured for receiving from said at least one server information customized on the basis of said at least a portion of the user model made available to the server.

43. The terminal of claim 42, configured for sending to said server information leading to store and subsequently delete at the server said at least a portion of the user model.

44. The terminal of claim 42, wherein said user model is compliant to the MPEG-21 standard.

45. The terminal of claim 42, wherein said user model manager module is configured for making available to said at least one server a partial copy of said user model containing only a part of the data contained in said user model.

46. The terminal of claim 42, in a system comprising a plurality of servers providing respective information contents configured for accessing said plurality of servers by using the same user model provided in said user terminal by sending at least a respective portion of said user model from said user terminal to the servers of said plurality of servers.

47. The terminal of claim 42, comprising a data carrier for storing said user model, whereby said data carrier is adapted for use with a plurality of user terminals.

48. A server for providing to at least one user terminal information content in relation to a service customized according to a user model, said server comprising a server engine for:
receiving from said at least one user terminal at least a portion of said user model selected on the basis of the service, whereby said at least a selected portion of the user model is made available to said server;
customizing said information on the basis of said at least a selected portion of the user model made available to the server; and
sending said customized information from said server to said user terminal.

49. The server of claim 48, comprising:
a storing module for storing at the server said at least a portion of the user model; and
a deleting module for deleting from the server said at least a portion of the user model.

50. A computer program product directly loadable into the memory of a digital computer and comprising software code portions for performing the steps of the method of claim 27 when said product is capable of being run on a computer.

51. A computer program product directly loadable into the memory of a digital computer and comprising software code portions implementing the terminal of claim 42 when said product is capable of being run on a computer.

52. A computer program product directly loadable into the memory of a digital computer and comprising software code portions implementing for performing the server of claim 48 when said product is capable of being run on a computer.
